(19) United States
(12) Patent Application Publication
(10) Pub. No.: US 2008/0310841 A1
(43) Pub. Date: Dec. 18, 2008

(54) Long-Reach Wavelength Division Multiplexing Passive Optical Network (Wdm-Pon)

(75) Inventors: Chang-hee Lee, Daejeon (KR); Sang-mook Lee, Daejeong (KR); Sil-gu Mun, Daegu (KR)

Correspondence Address: HARNESS, DICKEY & PIERCE, P.L.C., P.O. BOX 828, BLOOMFIELD HILLS, MI, 48303, US

(73) Assignee: KOREA ADVANCED INSTITUTE OF SCIENCE AND TECHNOLOGY, Daejon (KR)

(21) Appl. No.: 11/922,196

(22) PCT Filed: May 18, 2006
(86) PCT No.: PCT/KR2006/001861

§ 371 Date: Jul. 11, 2008

(30) Foreign Application Priority Data
May 20, 2005 (KR) 10-2005-0042603

(51) Int. Cl. H04B 10/20

(52) U.S. Cl. 398/63

(57) ABSTRACT

The present invention relates to a long-reach wavelength division multiplexing passive optical network(WDM-PON), and especially to the long-reach WDM-PON capable of ensuring economic and stable QoS (Quality of Service). The Long-reach WDM-PON in accordance with the present invention includes an optical transmitter/receiver located at central office and each optical network termination; wavelength division multiplexer/demultiplexer located at said central office and remote node; and broadband incoherent light source which is connected with a long-reach single-mode fiber to said wavelength division multiplexer/demultiplexer and spectrum-sliced and injected into the transmitters located at said central office and each optical network termination.

### TECHNICAL FIELD

The present invention relates to a long-reach wavelength division multiplexing passive optical network(WDM-PON), and especially to the long-reach WDM-PON capable of ensuring economic and stable QoS(Quality of Service).

### BACKGROUND ART

The bandwidth required for each subscriber is being ever increased for providing an integrated service with voice telephone service, data communication service and high definition video service through a single access network.

For stably providing the high bandwidth services, PON based on optical fiber has been actively studied. There are TDM-PON and WDM-PON in representative techniques for PON. Generally, the maximum transmission distance from central office(CO) to optical network termination(ONT) in a PON is considered as 20 km.

FIG. 1 shows the architecture of passive optical network including a schematic diagram for a central office for providing a variety of services in accordance with prior arts. As shown in FIG. 1, a satellite broadcasting(11a), high definition TV(HDTV, 11b) are connected to a streamer(14) in the CO(10), and EoD(Education on Demand) server(12a), VoD(Video on Demand) server(12b), Internet server(12c) are connected to a switch(15). POTS(Plain Old Telephone Service, 13a) and VoIP(voice over Internet Protocol, 13b) are connected to an optical line termination(OLT, 16), and said streamer(14) and switch(15) are connected to the OLT(16), as well. In TDM-PON, the central office(10) is connected to each optical network termination via optical fiber(20) and 1×N optical splitter(30) for accommodating a lot of optical network terminations.

FIG. 2 shows a diagram for the service coverage of each central office according to the maximum transmission distance of access network, in accordance with prior arts. As illustrated in FIG. 2, there is certain service coverage of central office in a PON according to the maximum transmission distance from a central office to optical network terminations. Thereby, long-reach transmission from a central office to optical network terminations can largely increase the service coverage of a single central office.

FIG. 2a shows that 9 central offices(CO1, CO2, CO3, CO4, CO5, CO6, CO7, CO8, CO9) are required for serving a certain area with passive optical network in which the maximum transmission distance is 20 km. In order to provide a variety of services to all subscribers, each central office needs the equipments shown in FIG. 1. Moreover, central office should be located at the expensive downtown area.

### DISCLOSURE OF INVENTION

### Technical Problem

Considering only the equipments having to be employed in central offices, as the case shown in FIG. 2a, the equipments depicted in FIG. 1 can be employed in only CO5, and thereby a centralized CO is accomplished, and all information is distributed from centralized CO5 to the distribution network composed of other central offices. In this case, while the number of equipments being employed in each central office would be reduced, additional distribution network is required and the equipments for the above distribution network should be required in each central office. Moreover, since the number of hop becomes to be increased due to the signal processing in these equipments, there is a disadvantage in decreasing the QoS of a signal.

However, if the transmission distance of optical access network as shown in FIG. 2b is increased to 60 km, it is enough to have only one central office for covering the same service area as the case shown in FIG. 2a. In this case, since the signal is transmitted through optical fiber from subscriber to the central office, signal processing systems such as distribution network and distribution network equipments can be removed. Thereby, QoS can be easily ensured.

Therefore, long-reach PON can enormously reduce the number of central offices in the whole access network, thereby the places for setting up the central offices are not required. The reduction of the number of above places enables the number of equipments employed in central office to be reduced, and thus there is advantage in being capable of reducing the cost of the systems. Moreover, since it is possible to communicate between subscribers and the central office in a single hop, QoS provided to each subscriber can also be improved.

And there is no need to employ a lot of central offices in the downtown area, and the central office employed outside the downtown area can stably provide high bandwidth services to each subscriber located at the downtown area through the long-reach PON. From the above advantages, the long-reach PON can reduce the initial construction cost for optical access network, and not only increase the QoS of the signal by reducing the number of hop, but tremendously reduce the maintenance cost of the network.

Recently, for the purpose of maximizing the above advantages, a study on enlarging the transmission distance from central office to each subscriber in TDM-PON has been reported. However, in order to accommodate a lot of subscribers through a single optical fiber, TDM-PON uses an optical splitter having big splitting ratio.

the splitting ratio of the optical splitter is higher, the insertion loss of the optical splitter is also increased. The insertion loss of 1×64 optical splitter is about 20 dB(18 dB of intrinsic loss+2 dB of extrinsic loss).

As compared to the above TDM-PON, the insertion loss of arrayed waveguide grating(AWG) mainly used as wavelength division multiplexer and wavelength division demultiplexer required for implementing WDM-PON is about 10 dB(2 AWGs: 2×5 dB).

Moreover, for the purpose of providing the same bandwidth in TDM-PON as provided to each subscriber in WDM-PON, the transmission speed of TDM-PON should equal to the multiplication of the splitting ratio of optical splitter by the transmission speed of WDM-PON. Such a high-speed transmission in a TDM-PON degrades the sensitivity of a receiver. For example, with a view to increasing the transmission speed from 155 Mb/s to 2.5 Gb/s, the sensitivity of a receiver is degraded about 9 dB. The required transmission speed for the case of 64 splitting TDM-PON becomes to be increased to 10 Gb/s(155 Mb/s×64), and the sensitivity of the receiver is more severely degraded.

As explained in the above, it is unavoidable to use optical amplifier between central office and subscriber to compensate the high splitting loss of the optical splitter and the degradation of receiver sensitivity caused by high transmission speed for guaranteeing high bandwidth for each subscriber in TDM-PON. Moreover, the chromatic dispersion compensator is necessary for long-reach transmission with high transmission speed for guaranteeing high bandwidth for each subscriber in TDM-PON.

The use of these optical amplifier and chromatic dispersion compensator has disadvantages of increasing the cost in PON and decreasing the reliability of the system.

### Technical Solution

For the purpose of resolving the above problems, the objectives of the present invention are to increase the transmission distance from central office to each optical network termination(ONT) without using both optical amplifier and chromatic dispersion compensator, and thereby to provide a long-reach wavelength division multiplexing passive optical network being capable of ensuring economic and stable QoS.

### Advantageous Effects

As shown in the above, the long-reach wavelength division multiplexing passive optical network in accordance with the present invention increases the service coverage of a single access network by implementing WDM-PON which is capable of long-reach transmission. These facts can tremendously decrease the number of central office in the whole access network, and thereby decrease the initial facility investment cost of the systems, and increase the QoS of the signal by reducing the number of hop.

Moreover, there is no need to set up central office in the dense downtown area by setting up central office outside the downtown, and thereby high bandwidth service can be stably provided with low cost facility investment by being capable of being connected to each optical network termination located inside the downtown through long-reach PON. By doing this, both optical amplifier and chromatic dispersion compensator between central office and each optical network termination are not required, and thus the cost of optical access network can be reduced and the reliability of the network can be increased.

### BRIEF DESCRIPTION OF THE DRAWINGS

FIG. 1 shows the architecture of passive optical network including a schematic diagram for central office for providing a variety of services, in accordance with prior arts.

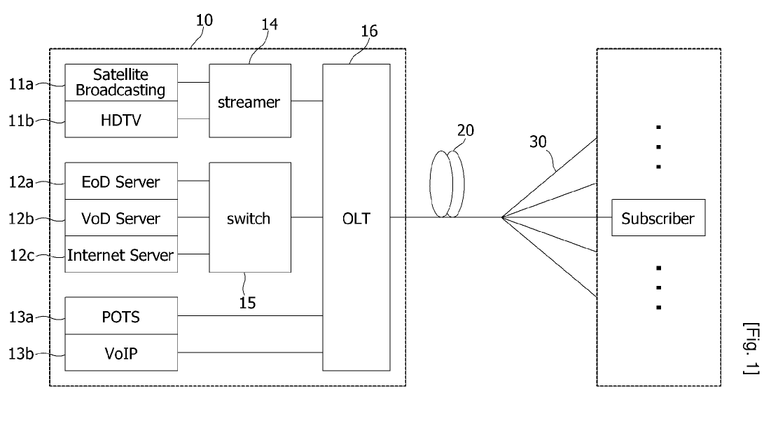

FIG. 2 shows a diagram for the service coverage of central offices according to the maximum transmission distance of access network, in accordance with prior arts.

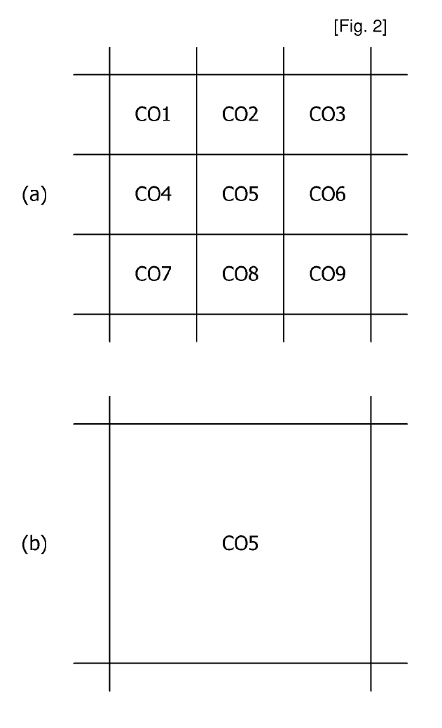

FIG. 3 shows the architecture of long-reach wavelength division multiplexing passive optical network in accordance with the present invention.

FIG. 4 shows an optical spectrum measured in the system of FIG. 3 in accordance with the present invention.

FIG. 5 shows received optical power of upstream and downstream in the system of FIG. 3 in accordance with the present invention.

FIG. 6 shows packet loss rate of upstream measured according to the attenuation of variable optical attenuator in the system of FIG. 3 in accordance with the present invention.

### BEST MODE FOR CARRYING OUT THE INVENTION

Long-reach WDM-PON in accordance with the present invention includes an optical transmitter/receiver located at central office and each optical network termination; wavelength division multiplexer/demultiplexer located at said central office and remote node; and broadband incoherent light source which is connected with a long-reach single-mode fiber to said wavelength division multiplexer/demultiplexer and spectrum-sliced and injected into the transmitters located at said central office and each optical network termination.

### Mode for the Invention

Hereinafter, referring to appended drawings, the structures and operation principles for the embodiments of present invention are described in detail.

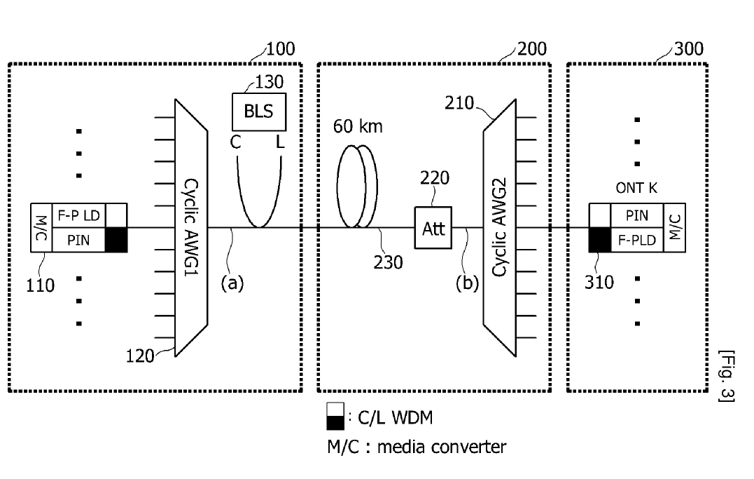

FIG. 3 shows the architecture of long-reach wavelength division multiplexing passive optical network in accordance with the present invention. As shown in FIG. 3, long-reach wavelength division multiplexing passive optical network comprises a central office(CO)(100), a remote node(RN)(200), and optical network terminations(300). The CO(100) is connected to the RN(200) with a 60 km single-mode fiber(230).

The present invention uses wavelength-locked Fabry-Perot Laser Diode(F-P LD) presented in the Korea patent no. 0325687(Patent Title: A low-cost WDM source with an incoherent light injected Fabry-Perot semiconductor laser diode, 8 Feb. 2002) as a light source of optical transmitter/receiver(110, 310), and is also capable of using semi-conductor optical amplifier(SOA), or distributed feedback laser diode (DFB LD) as a light source. Herein, light emitting diode, spontaneous emitting light, super-luminescent light-emitting diode, or semiconductor laser can be used as the above broadband incoherent light source (BLS).

A 50 GHz(0.4 nm) is used for the channel spacing of the above F-P LD, C-band 35-channel(1540 nm˜1553.6 nm) is used for upstream signal, and L-band 35-channel(1570.9 nm˜1584.7 nm) is used for downstream signal. Moreover, the mode spacing of the above F-P LD is about 0.56 nm, front facet of F-P LD is anti-reflection(AR)-coated for increasing injection efficiency of spectrum-sliced BLS, and the reflectivity ranges 0.03%-0.3%.

The power of spectrum-sliced C-band BLS(130) injected into F-P LD located at each optical network termination is -21.5 dBm/0.2 nm(total -19.3 dBm), and the power of spectrum-sliced L-band BLS(130) injected into F-P LD located at central office is −16 dBm/0.2 nm(total −13.8 dBm). Arrayed waveguide grating(AWG)(120, 210) used for wavelength division multiplexer/demultiplexer has 50 GHz channel spacing and 34 GHz passband. AWG (120, 210) with periodic characteristics is used for multiplexing one band along with demultiplexing another one band. Thin film filter instead of AWG (120, 210) can be used for the above wavelength division multiplexer/demultiplexer. Moreover, an variable optical attenuator (220) is inserted between optical fiber and AWG (120, 210) for measuring the performance of the system in accordance with the present invention.

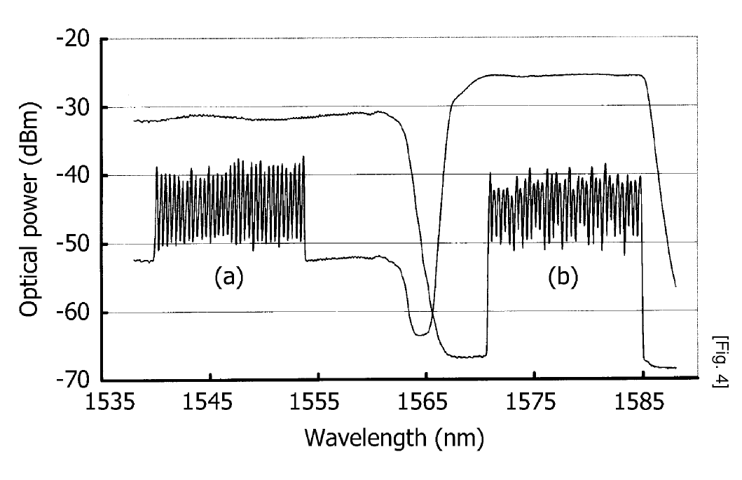

FIG. 4 shows an optical spectrum measured in the system of FIG. 3 in accordance with the present invention. As shown in FIG. 4, FIG. 4 shows the optical spectrum measured at (a) and (b) of FIG. 3 using 1:9 optical coupler. The curve (a) of FIG. 4 is composed of multiplexed 50 GHz spaced 35-channel upstream signal and L-band BLS, and the curve (b) of FIG. 4 is composed of multiplexed 50 GHz spaced 35-channel downstream signal and C-band BLS.

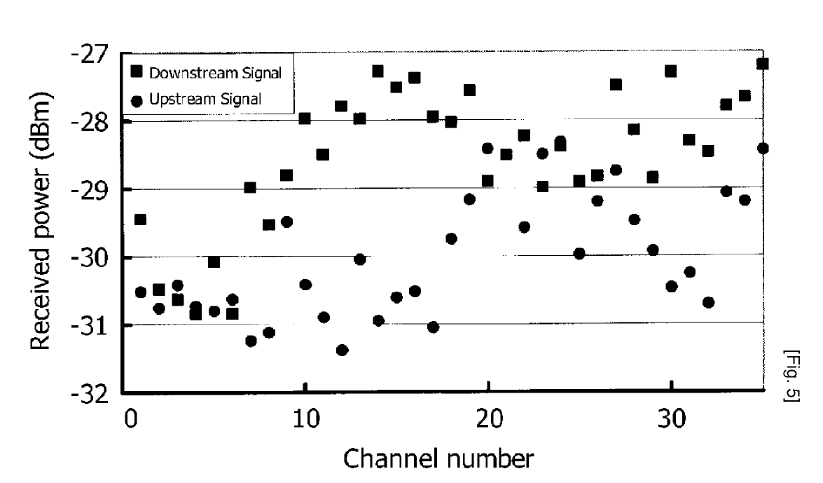

FIG. 5 shows received optical power of upstream and downstream in the system of FIG. 3 in accordance with the present invention. As shown in FIG. 5, the received optical power of upstream signal is −28.3 dBm˜−31.4 dBm, and the received optical power of downstream signal is −27.2 dBm˜−30.8 dBm.

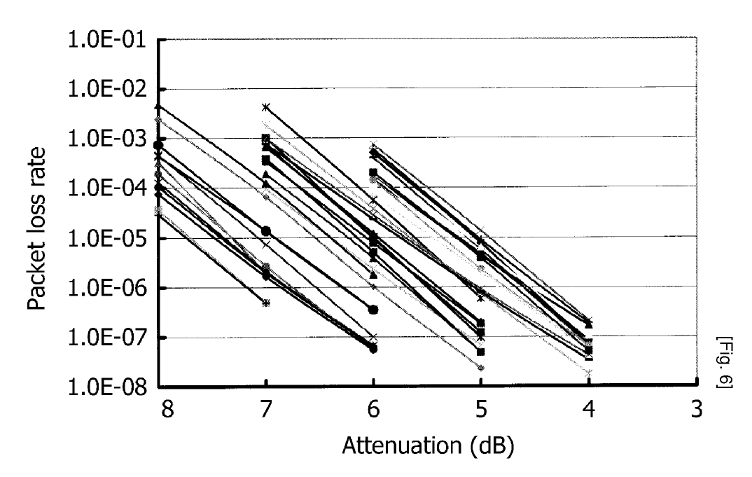

FIG. 6 shows packet loss rate of upstream measured signals according to the attenuation of the variable optical attenuator in the system of FIG. 3 in accordance with the present invention. As shown in FIG. 6, the packet loss rate of the upstream signal was measured according to the attenuation after inserting variable optical attenuator connected with 60 km optical fiber between two periodic AWGs of FIG. 3 is shown in FIG. 6. All upstream channels are directly modulated by using 100-BASE ethernet packet (data rate=125 Mb/s). Only wavelength-locked downstream signal is suffered to be attenuated by variable optical attenuator in downstream channels, but on the other hand, since both BLS injected into F-P LD and wavelength-locked upstream signal are suffered to be attenuated in upstream channels, the more attenuation is increased, the more upstream is influenced than the downstream. Packet loss rate can be obtained from lost packet (transmitted packet—received packet) divided by transmitted packet. The implemented WDM-PON can realize 60 km long-reach transmission without using optical amplifier and chromatic dispersion compensator between central office and optical network termination.

Since those having ordinary knowledge and skill in the art of the present invention will recognize additional modifications and applications within the scope thereof, the scope of present invention should not be limited to the embodiments and drawings described above, but should be determined by the Claims.

### INDUSTRIAL APPLICABILITY

The present invention relates to a long-reach wavelength division multiplexing passive optical network (WDM-PON), and especially to the long-reach WDM-PON capable of ensuring economic and stable QoS(Quality of Service). Thus, the system in accordance with the present invention is applicable to optical access network as a cost effective solution.

1. A long-reach wavelength division multiplexing passive optical network including
optical transmitter/receiver located at central office and each optical network termination;
wavelength division multiplexer/demultiplexer located at said central office and remote node; and
broadband incoherent light source which is connected with a long-reach single-mode fiber to said wavelength division multiplexer/demultiplexer and spectrum-sliced and injected into the transmitters located at said central office and each optical network termination.

2. The long-reach wavelength division multiplexing passive optical network claimed in claim 1, characterized in that
said light source of optical transmitter/receiver uses one of wavelength-locked F-P LD, semiconductor optical amplifier with externally injected incoherent light source, or distributed feedback laser.

3. The long-reach wavelength division multiplexing passive optical network claimed in claim 2, characterized in that
front facet of F-P LD is anti-reflection(AR)-coated for increasing injection efficiency of said externally injected incoherent light source.

4. The long-reach wavelength division multiplexing passive optical network claimed in claim 1, characterized in that arrayed waveguide grating or thin film filter is used for said wavelength division multiplexer/demultiplexer.

5. The long-reach wavelength division multiplexing passive optical network claimed in claim 1, characterized in that
error correction code is used for said optical transmitter/receiver in order to increase transmission distance.

6. The long-reach wavelength division multiplexing passive optical network claimed in claim 1, characterized in that
said broadband incoherent light source is one of light emitting diode, spontaneous emitting light, super-luminescent light-emitting diode, or semi-conductor laser.
